(19) United States
(12) Patent Application Publication
(10) Pub. No.: US 2013/0238317 A1
(43) Pub. Date: Sep. 12, 2013

(54) VOCABULARY LOOK UP SYSTEM AND METHOD USING SAME

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventor: QIANG YOU, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/790,365

(22) Filed: Mar. 8, 2013

(30) Foreign Application Priority Data
Mar. 8, 2012 (CN) 201210059588.9

(51) Int. Cl. G10L 15/18

(52) U.S. Cl. CPC G10L 15/1815
USPC 704/9

(57) ABSTRACT

A vocabulary look up in an electronic apparatus includes a voiceprint acquiring module, a matching module, a reminding module, and a spelling module. The voiceprint acquiring module analyzes sounds collected by an audio collector to acquire voiceprints from the collected sounds. The matching module retrieves vocabulary information of a word associated with an acquired voiceprint in a lookup table. The reminding module displays a pop-up window to get the user to spell out the word to be looked up when more than one word is associated with the acquired voiceprint in the lookup table. The spelling module acquires the voiceprints of the letters constituting the word to be looked up to determine and displays the word to be looked up.

### 1. TECHNICAL FIELD

The disclosure generally relates to vocabulary learning, and particularly, to a vocabulary look up and method.

### 2. DESCRIPTION OF RELATED ART

An electronic dictionary usually receives data via a keyboard. Thus, a user of the dictionary must have his/her hands free to type using the keyboard when he/she wants to look up a word, which may be not convenient and results in low efficiency.

Therefore, it is desirable to provide a testing system and method which can overcome the above-mentioned problems.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a vocabulary look up system.

FIG. 2 is a flowchart of a first embodiment of a vocabulary look up method.

FIG. 3 is a flowchart of a second embodiment of a vocabulary look up method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable median include CDs, DVDs, BLU-RAY, flash memory, and hard disk drives.

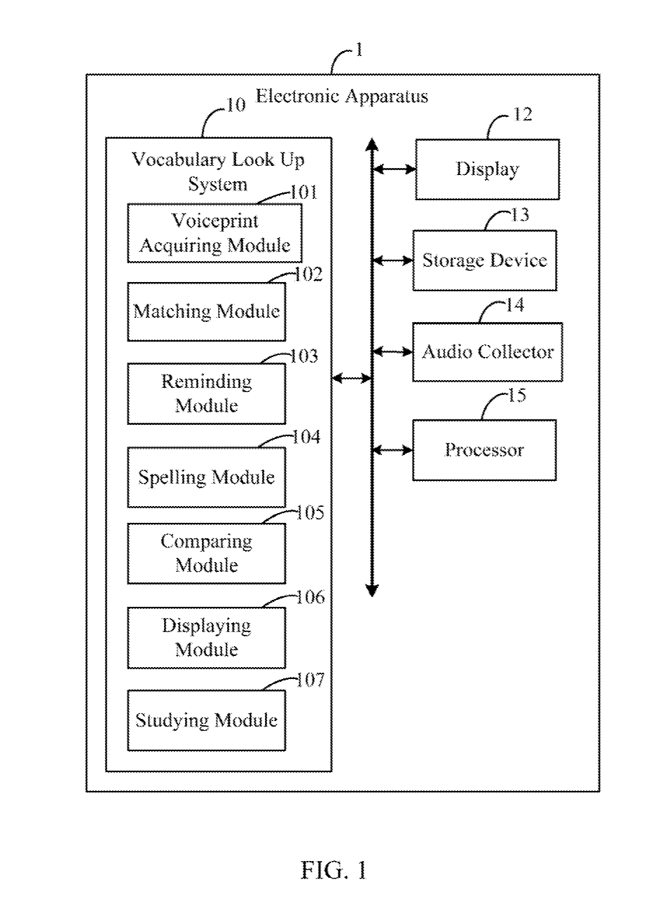

FIG. 1 is a block diagram of one embodiment of an electronic apparatus 1 comprising a vocabulary look up system 10. In one embodiment, the electronic apparatus 1 further includes a display 12, a storage device 13, at least one processor 15, and an audio collector 14. The display 12, the at least one storage device 13, and the audio collector 14 are directly or indirectly electrically connected, for exchange of data. In this embodiment, the electronic apparatus 1 may be, but is not limited to, a mobile intelligent terminal, such as a tablet computer or a cellular phone.

The audio collector 14 collects sound from a surrounding environment of the electronic apparatus 1, and stores the sound as audio data in a specific section of the storage device 13. A voiceprint is a spectrogram of a voice. Because a particular word has a substantially common voiceprint even when spoken by different people, an individual word can be distinguished from other words via a human voice pronouncing the word. Thus, the human voice in the collected audio data can be used to determine the word to be looked up.

The storage device 13 may be, but is not limited to, a hard disk, or a dedicated memory, such as an EPROM, HDD, or flash memory. The storage device 13 stores a lookup table including a collection of words (vocabulary information) associated with a collection of voiceprints of the pronunciation of each word. The vocabulary information is dictionary entries that help people to understand and learn the word, such as phonetic symbols of the word, explanations as to the meaning of the word, some sample sentences of the word, for example.

In some embodiments, the display 12 may be, but is not limited to, a thin portable display, such as a liquid crystal display, a light emitting diode display, or an organic light emitting diode display. Furthermore, the display 12 includes a touch panel to allow various touch control functions.

The vocabulary look up 10 includes a voiceprint acquiring module 101, a matching module 102, a reminding module 103, a spelling module 104, a comparing module 105, a displaying module 106, and a studying module 107. Computerized codes of the vocabulary look up 10 can be embedded into an operation system of the electronic apparatus 1, or stored in the storage device 13 and executed by the processor 15.

The voiceprint acquiring module 101 analyzes the audio data stored in the storage device 13 to acquire voiceprints from the collected audio data. The voiceprint acquiring module 101 may cache the voiceprints in the storage device 13.

The matching module 102 retrieves vocabulary information of a word associated with the acquired voiceprint in the lookup table, and generates an instruction to verify when one or more words are associated with one acquired voiceprint in the lookup table and a failure instruction when there is a failure to retrieve any word associated with the acquired voiceprint in the lookup table.

The reminding module 103 displays a pop-up window on the display 12 to ask the user to spell out the word to be looked up when the instruction to verify is received from the matching module 102. The reminding module 103 displays a pop-up dialog box to warn the user of a failure of a word to be looked up when a failure instruction is received from the matching module 102. The pop-up window includes an accept button and a refuse button. The reminding module 103 activates the spelling module 104 when the user presses the accept button. The reminding module 103 sends a retrieve instruction to the matching module 102, whereupon the matching module 102 retrieves the vocabulary information of any and all words associated with the acquired voiceprint when the retrieve instruction is received.

The spelling module 104 acquires the voiceprints of the letters which constitute the word to be looked up via the voiceprint acquiring module 101. The spelling module 104 acquires the voiceprints of each letter from the voiceprint acquiring module 101 after a first predetermined time interval. If the spelling module 104 acquires no voiceprint after a second predetermined time interval from the last acquiring of the voiceprint, the spelling module 104 combines the acquired letters to form the word to be looked up. The second predetermined time interval is a multiple of the first time interval. In this embodiment, the second time interval is four times longer than the first time interval.

The comparing module 105 compares a voiceprint being acquired with a previously acquired voiceprint. The comparing module 105 sends a look up instruction to the matching module 102 when the voiceprint being acquired is the same as the previously acquired voiceprint. The matching module 102 retrieves the vocabulary information of the word associated with the acquiring voiceprint in the lookup table when the matching module 102 receives the look up instruction.

The displaying module 106 displays, in written form, the vocabulary information of the word to be looked up.

The studying module 107 copies the vocabulary information of the words which have been looked up in a directly accessible area of the storage device 13. Therefore, the user can review the word at any time.

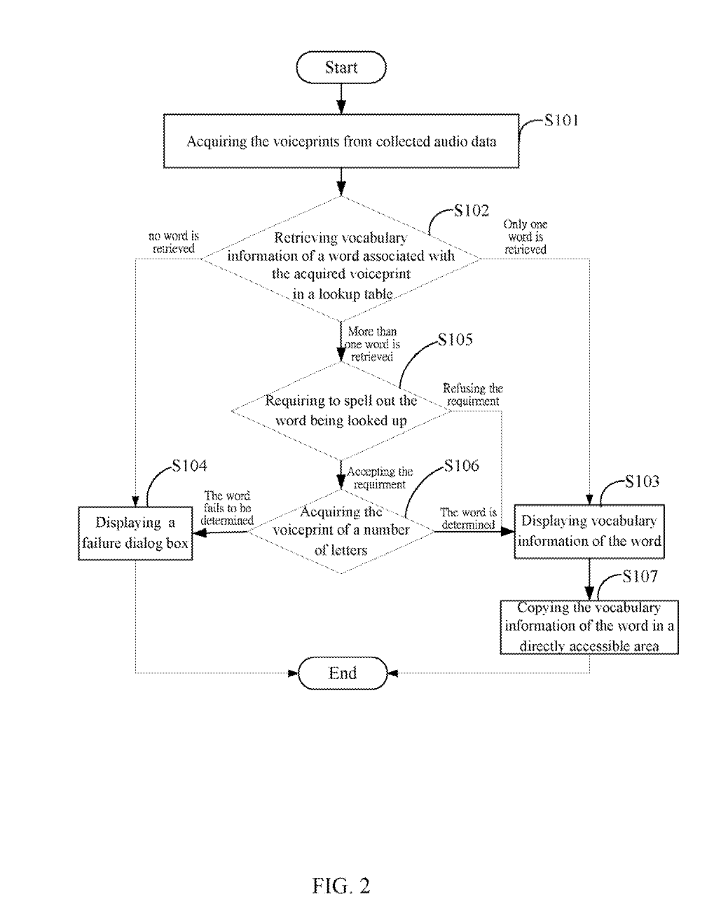

FIG. 2 is a flowchart of a first embodiment of a vocabulary look up method. Depending on the embodiment, additional steps may be added, other deleted, and the ordering of the steps may be changed.

In step S101, the voiceprint acquiring module 101 analyzes the collected audio data to acquire voiceprints from the collected audio data.

In step S102, the matching module 102 retrieves vocabulary information of one or more words associated with an acquired voiceprint in the lookup table.

In step S103, the matching module 102 sends a displaying instruction to the displaying module 106 when the matching module 102 retrieves only one word which is associated with the acquired voiceprint in the lookup table. The displaying module 106 displays vocabulary information of the single word.

In step S104, the matching module 102 sends a failure instruction to the reminding module 103 when the matching module 102 fails to retrieve any word associated with the acquired voiceprint in the lookup table. The reminding module 103 displays a pop-up dialog box on the display 12 to warn the user of a failure of word looking up when a failure instruction is received from the matching module 102.

In step S105, the matching module 102 sends an instruction to verify to the reminding module 103 when the matching module 102 retrieves more than one word which is associated with the acquired voiceprint in the lookup table. The reminding module 103 displays a pop-up window on the display 12 to require the user to spell out the word to be looked up.

In step S106, the spelling module 104 acquires the voiceprint of the letters constituting the word to be looked up and combines the letters to form the word to be looked up. And then, implementing step S103, the displaying module 106 displays vocabulary information of the word spelled out by the spelling module 104.

The matching module 102 retrieves the vocabulary information of all the different words associated with one acquired voiceprint when the user is incapable of spelling out the word to be looked up or when the matching module 102 does not recognize the spelling which is entered by the user. And then, implementing step S103, the displaying module 106 displays the vocabulary information of all the different words associated with the one acquired voiceprint.

The spelling module 104 controls the reminding module 103 to display a pop-up dialog box for warning the user of a failure of a word looking up when the word combined by the spelling module 104 is different from all of the words have been retrieved by the matching module 102.

In step S107, the studying module 107 copies the vocabulary information of the word to be looked up in a directly accessible area of the storage device 13.

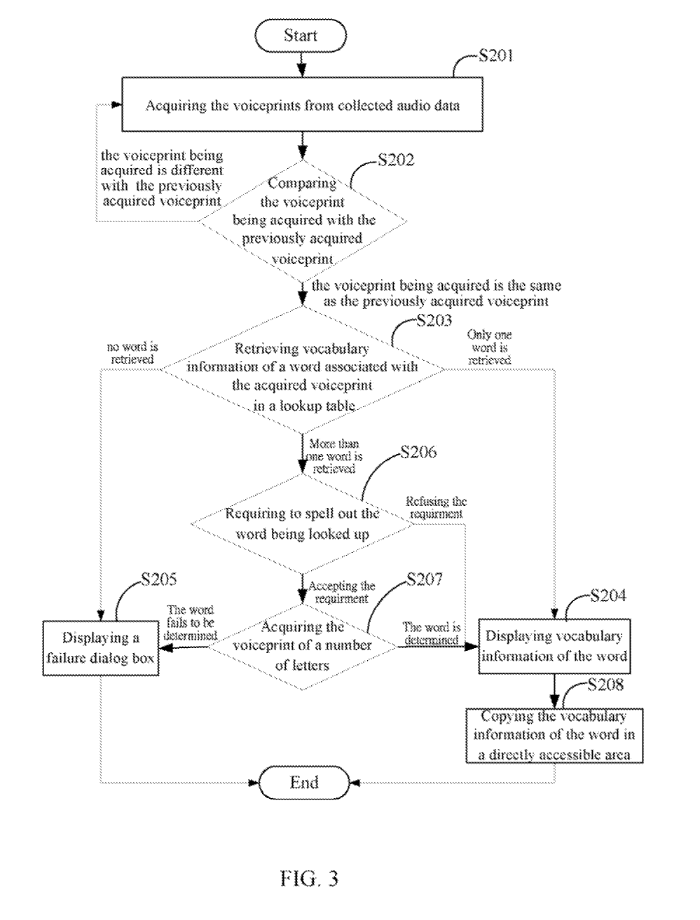

FIG. 3 is a flowchart of a second embodiment of a vocabulary look up method. Depending on the embodiment, additional steps may be added, other deleted, and the ordering of the steps may be changed.

In step S201, the voiceprint acquiring module 101 analyzes collected audio data to acquire a voiceprint and caches the voiceprint in the storage device 13.

In step S202, the comparing module 105 compares the voiceprint being acquired with a previously acquired voiceprint. Step S201 is implemented when the acquiring voiceprint is different with the previous acquired voiceprint.

In step S203, the matching module 102 retrieves vocabulary information of one or more words associated with the acquiring voiceprint in the lookup table when the acquiring voiceprint is the same as the previous acquired voiceprint.

In step S204, the matching module 102 sends a displaying instruction to the displaying module 106 when the matching module 102 is able to retrieve only one word which is associated with the acquired voiceprint in the lookup table. The displaying module 106 displays vocabulary information of the single word.

In step S205, the matching module 102 sends a failure instruction to the reminding module 103 when the matching module 102 fails to retrieve any word which is associated with the acquired voiceprint in the lookup table. The reminding module 103 displays a pop-up dialog box to warn the user of a failure of a word looking up when a failure instruction is received from the matching module 102.

In step S206, the matching module 102 sends an instruction to verify to the reminding module 103 when the matching module 102 is able to retrieve more than one word which is associated with the acquired voiceprint in the lookup table. The reminding module 103 displays a pop-up window to require the user to spell out the word to be looked up.

In step S207, the spelling module 104 acquires voiceprints of the letters constituting the word to be looked up and combines the letters to form the word to be looked up. And then, step S204 is implemented, the displaying module 106 displays vocabulary information of the word spelled out in written form by the spelling module 104.

The matching module 102 retrieves the vocabulary information of all the different words associated with the one acquired voiceprint when the user is unable to spell out the word to be looked up. And then, implementing step S204, the displaying module 106 displays the vocabulary information of all the different words associated with the one acquired voiceprint.

The spelling module 104 controls the reminding module 103 to display a pop-up dialog box to warn the user of a failure of a word looking up when combined by the spelling module 104 is different from all of the words have been retrieved by the matching module 102.

In step S208, the studying module 107 stores the vocabulary information of all the words which have been looked up in a directly accessible area of the storage device 13.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An electronic apparatus, comprising:
a storage device that stores a lookup table comprising a collection of vocabulary information about a plurality of words associated with a collection of voiceprints of the pronunciation of each word;
a display;
an audio collector that collects sound from a surrounding environment and stores the sound as audio data in the storage device; and
a vocabulary look up, comprising:
a voiceprint acquiring module that analyzes the audio data stored in the storage device to acquire the voiceprint from the collected audio data;
a matching module that retrieves vocabulary information of one or more words associated with the acquired voiceprint in the lookup table;
a reminding module that displays a pop-up window on the display, to ask the user to spell out the word to be looked up when the matching module retrieves more that one word is associated with the acquired voiceprint in the lookup table; and
a spelling module acquires the voiceprints of the letters which constitute the word to be looked up via the voiceprints acquiring module to determined the word to be looked up.

2. The electronic apparatus of claim 1, the vocabulary look up further comprises a comparing module that compares a voiceprint being acquired with the previously acquired voiceprint and controls the matching module to retrieve vocabulary information of a word associated with the acquired voiceprint when the word being acquired is same as the previously acquired voiceprint.

3. The electronic apparatus of claim 1, wherein the vocabulary look up further comprises a studying module that copies the vocabulary information of the words which have been looked up in a directly accessible area of the storage device.

4. The electronic apparatus of claim 1, wherein the matching module controls the reminding module to display a pop-up dialog box on the display that warns the user a failure of a word looking up when fails to retrieves any word is associated with the acquired voiceprint in the lookup table.

5. The electronic apparatus of claim 1, wherein the pop-up window includes an accept button and a refuse button, the reminding module activates the spelling module when the user presses the accept button.

6. The electronic apparatus of claim 5, wherein the reminding module controls the matching module to retrieve the vocabulary information of any and all words associated with the acquired voiceprint when the user presses the refusing button.

7. The electronic apparatus of claim 1, wherein the spelling module acquires a voiceprint of each letter from the voiceprints acquiring module after a first predetermined time interval, the spelling module combines the acquired letters to form the word to be looked up when the spelling module acquires no voiceprint after a second predetermined time interval from the last acquiring of the voiceprint.

8. The electronic apparatus of claim 7, wherein the second predetermined time interval is a multiple of the first time interval.

9. The electronic apparatus of claim 8, wherein the second time interval is four times longer than the first time interval.

10. A vocabulary look up method being performed by execution of computer readable program code by a processer of an electronic apparatus, the electronic apparatus comprising a storage device stores a lookup table comprising a collection of vocabulary information about a plurality of words associated with a collection of the voiceprints of the pronunciation of each word and an audio collector that collects sound from the surrounding, the method comprising:
analyzing the collected audio data to acquire the voiceprint;
retrieving vocabulary information of one or more words associated with the acquired voiceprint in the lookup table;
displaying a pop-up window to require the user to spell out the word to be looked up when more than one word which is associated with the acquired voiceprint in the lookup table;
determining the word to be looked up by acquiring the voiceprint of the letters constituting the word to be looked up; and
displaying vocabulary information of the word to be looked up.

11. The method as claimed in claim 10, further comprising:
copying the vocabulary information of the word to be looked up in a directly accessible area of the storage device.

12. The method as claimed in claim 10, further comprising:
displaying a pop-up dialog box to warn the user a failure of word looking up when no word is associated with the acquired voiceprint in the lookup table.

13. The method as claimed in claim 10, further comprising:
retrieving the vocabulary information of all the different words associated with one acquired voiceprint when fails to acquire the voiceprint of the letters.

14. A vocabulary look up method being performed by execution of computer readable program code by a processer of an electronic apparatus, the electronic apparatus comprising a storage device stores a lookup table comprising a collection of vocabulary information about a plurality of words associated with a collection of the voiceprints of the pronunciation of each word and an audio collector that collects sound from the surrounding, the method comprising:
analyzing the collected audio data to acquire the voiceprint and caching the voiceprint in the storage device;
comparing the voiceprint being looked up with the previously acquired voiceprint;
retrieving vocabulary information of one or more words associated with the acquiring voiceprint in the lookup table when the acquiring voiceprint is the same as the previously acquired voiceprint;
displaying a pop-up window to require the user to spell out the word to be looked up when more than one word which is associated with the acquired voiceprint in the lookup table;
determining the word to be looked up by acquiring the voiceprint of the letters constituting the word to be looked up; and
displaying vocabulary information of the word to be looked up.

15. The method as claimed in claim 14, further comprising:
copying the vocabulary information of the word to be looked up in a directly accessible area of the storage device.

16. The method as claimed in claim 14, further comprising:
displaying a pop-up dialog box to warn the user a failure of word looking up when no word is associated with the acquired voiceprint in the lookup table.

17. The method as claimed in claim 14, further comprising:
retrieving the vocabulary information of all the different words associated with one acquired voiceprint when fails to acquire the voiceprint of the letters.
